(19) United States
(12) Patent Application Publication
(10) Pub. No.: US 2025/0007736 A1
(43) Pub. Date: Jan. 2, 2025

(54) PRODUCT MANAGEMENT SYSTEM, PRODUCT DEVICE, PRODUCT MANAGEMENT METHOD, AND NON-TRANSITORY COMPUTER READABLE MEDIUM

(71) Applicant: NEC Corporation, Minato-ku, Tokyo (JP)

(72) Inventor: Tsukasa KOBAYASHI, Tokyo (JP)

(73) Assignee: NEC Corporation, Minato-ku, Tokyo (JP)

(21) Appl. No.: 18/709,977

(22) PCT Filed: Mar. 16, 2022
(86) PCT No.: PCT/JP2022/012031

§ 371 Date: May 14, 2024

(51) Int. Cl. H04L 9/32; H04L 9/08

(52) U.S. Cl. CPC H04L 9/3268; H04L 9/0822; H04L 9/3247

(57) ABSTRACT

A product management system includes an issuance unit, an authentication unit, a data registration unit, and an output unit. When receiving a certificate issuance request from a product device, the issuance unit generates a public key certificate including a public key, an UID, and a signature of a certificate authority, and stores a secret key in an HSM. When receiving an authentication request from the product device, the authentication unit verifies the public key certificate, and verifies whether authentication data are signed with the secret key using the public key in the public key certificate. When receiving a use start request from the product device for which authentication has succeeded, the output unit reads, from a storage, product history data registered in association with the UID included in the public key certificate of the product device, and outputs output information regarding the product history data.

### TECHNICAL FIELD

The present disclosure relates to a product management system, a product device, a product management method, and a non-transitory computer readable medium.

### BACKGROUND ART

In recent years, security risks have been increasing due to falsification of inspection data of product devices, replacement of product devices, and the like in supply chains such as production, inspection, and distribution. For example, Patent Literature 1 discloses a method in which a hash value is calculated on the basis of item data attached to a delivered item and node identification data of a trader, and the hash value is attached as item data to a shipment item to be shipped to another trader.

### CITATION LIST

### Patent Literature

Patent Literature 1: International Patent Publication No. WO2021/002226

### SUMMARY OF INVENTION

### Technical Problem

However, the method described in Patent Literature 1 has a problem in that, if the shipment item is replaced or impersonated before the item data are attached thereto, it is difficult to verify such an event.

In view of the problem described above, an object of the present disclosure is to provide a product management system, a product device, a product management method, and a non-transitory computer readable medium capable of verifying the authenticity of the product device in a supply chain.

### Solution to Problem

A product management system according to an aspect of the present disclosure includes:
an issuance means for, in case of receiving a certificate issuance request from a product device including a hardware security module (HSM), generating a public key certificate including a public key of the product device, a UID that is information for uniquely identifying the product device, and a signature of a certificate authority, and setting a secret key that is paired with the public key of the product device in the HSM;
an authentication means for, in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
a data registration means for registering product history data of the product device in association with the UID of the product device; and
an output means for, in case of receiving a use start request from the product device for which the authentication has succeeded, reading the product history data registered in association with the UID by using at least the UID included in the public key certificate of the product device, and outputting output information regarding the product history data.

A product device according to an aspect of the present disclosure is configured to:
set, in case of receiving a public key certificate including a public key and a UID from the product management system, a secret key that is paired with the public key in an HSM and store the public key certificate in a storage; and
sign, when activated, authentication data by using the secret key set in the HSM, and transmit an authentication request including the public key certificate stored in the storage and the signed authentication data to the product management system.

A product management method according to an aspect of the present disclosure includes:
generating, in case of receiving a certificate issuance request from a product device including an HSM, a public key certificate including a public key of the product device, a UID that is information for uniquely identifying the product device, and a signature of a certificate authority, and setting a secret key that is paired with the public key of the product device in the HSM;
in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
registering product history data of the product device in association with the UID of the product device; and
reading, in case of receiving a use start request from the product device for which the authentication has succeeded, the product history data registered in association with the UID by using at least the UID included in the public key certificate of the product device, and outputting output information regarding the product history data.

A non-transitory computer readable medium according to an aspect of the present disclosure stores a program.

The program causes a computer to implement:
a function of, in case of receiving a certificate issuance request from a product device including an HSM, generating a public key certificate including a public key of the product device, a UID that is information for uniquely identifying the product device, and a signature of a certificate authority, and setting a secret key that is paired with the public key of the product device in the HSM;
a function of, in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
a function of registering product history data of the product device in association with the UID of the product device; and
a function of, in case of receiving a use start request from the product device for which the authentication has succeeded, reading the product history data registered in association with the UID by using at least the UID included in the public key certificate of the product device, and outputting output information regarding the product history data.

### Advantageous Effects of Invention

According to the present disclosure, it is possible to provide a product management system, a product device, a product management method, and a non-transitory computer readable medium capable of verifying the authenticity of the product device in a supply chain.

### BRIEF DESCRIPTION OF DRAWINGS

FIG. 1 is a block diagram illustrating a configuration of a system according to a first example embodiment.

FIG. 2 is a flowchart illustrating a flow of product management according to the first example embodiment.

FIG. 3 is a flowchart illustrating a flow of product management according to the first example embodiment.

FIG. 4 is a block diagram illustrating a configuration of a system according to a second example embodiment.

FIG. 5 is a diagram schematically illustrating a supply chain.

FIG. 6 is a block diagram illustrating a configuration of a product management system according to the second example embodiment.

FIG. 7 is a diagram for explaining data recorded in a data store.

FIG. 8 is a diagram illustrating an example of a data structure in the data store.

FIG. 9 is a block diagram illustrating a configuration of a product device according to the second example embodiment.

FIG. 10 is a block diagram illustrating a configuration of an SCM device according to the second example embodiment.

FIG. 11 is a sequence diagram illustrating an example of a flow of certificate issuance for a product device in a production process according to the second example embodiment.

FIG. 12 is a sequence diagram illustrating an example of a flow of product management in an inspection process according to the second example embodiment.

FIG. 13 is a flowchart illustrating an example of a flow of client certificate verification according to the second example embodiment.

FIG. 14 is a sequence diagram illustrating an example of a flow of certificate issuance for an SCM device according to the second example embodiment.

FIG. 15 is a sequence diagram illustrating an example of a flow of product management in processes after packaging according to the second example embodiment.

FIG. 16 is a sequence diagram illustrating an example of a flow of data verification in a field investigation process according to the second example embodiment.

FIG. 17 is a diagram illustrating an example of a data structure in a data store including production history data related to maintenance and discard.

FIG. 18 is a block diagram illustrating a configuration of a product management system according to a third example embodiment.

### EXAMPLE EMBODIMENT

### <Prior Examination by Inventor>

In recent years, security risks caused by supply chains have been increasing due to falsification of product history data such as product device inspection data, replacement of product devices, and the like. For the procurement of product devices in fields that require a particularly high level of security, procurement security guidelines such as National Institute of Standards and Technology (NIST) SP800 have been developed, and this trend is imminent in Japan as well.

A user who has purchased a product device has not been able to confirm that the product device has been produced, shipped, and delivered to the user in an authentic state at the start of use of the product device, that is, at the start of operation of the product device. Therefore, there is a possibility that the user uses a replaced or impersonated product device as it is in operation.

Here, there has been a precedent in which whether a product device is authentic is verified in a single process by checking the internal integrity of the product device itself after being produced. However, the authenticity of the product device cannot be guaranteed in all of the sections across the supply chain. In addition, in a case where a problematic event such as falsification of product history data or replacement or impersonation of the product device occurs in the middle of the supply chain, it is not possible to specify in which section the problematic event has occurred.

The following example embodiments provide a mechanism for a user who has purchased a product device to be able to verify, at the start of operation of the product device after the product device is delivered, that the product device is an authentic product device that has been properly produced with no replacement or impersonation of the product device or with no falsification of product history data.

### First Example Embodiment

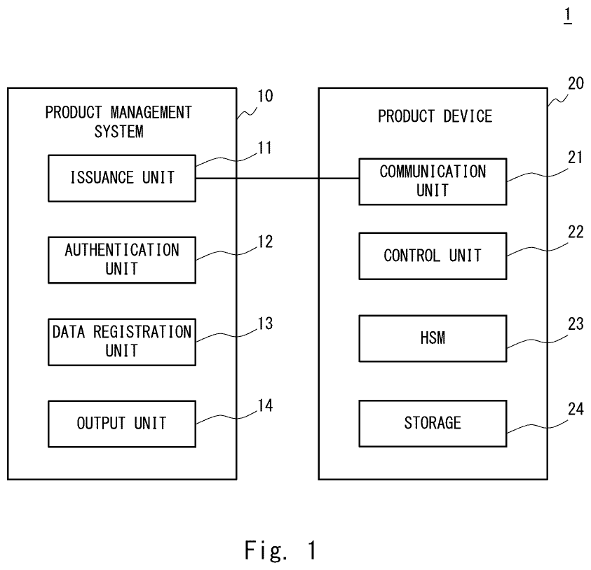

First, a first example embodiment of the present disclosure will be described. FIG. 1 is a block diagram illustrating a configuration of a system 1 according to the first example embodiment. The system 1 is a computer system related to a supply chain of a product device 20. In the present specification, the supply chain is a generic term for processes including production, inspection, inventory management, distribution, maintenance operation, and discard of the product device. The system 1 includes a product device 20 and a product management system 10.

### [Product Device 20]

The product device 20 is a personal computer, a tablet, a smartphone, or another information device purchased and used by a user. The product device 20 includes a communication unit 21, a hardware security module (HSM) 23, a storage 24, and a control unit 22.

The communication unit 21 is also referred to as a communication means. The communication unit 21 is an interface for communication with the product management system 10.

The HSM 23 is a module that manages a secret key distributed with respect to the product device 20 (hereinafter also referred to as a client secret key) not to be leaked to the outside of the product device 20 as the client secret key is set in itself. The HSM 23 has tamper resistance. For example, the HSM 23 is a module that has been certified by standards such as Federal Information Processing Standard (FIPS) 140-2, Common Criteria for Information Technology Security (CC), and Japan Cryptographic Module Validation Program (JCMVP).

Here, there are mainly two aspects in which the HSM 23 manages the client secret key. In the first aspect, the HSM 23 stores the client secret key inside the HSM 23. Since the HSM 23 has tamper resistance, the client secret key can be prevented from being leaked outside the HSM 23 by storing the client secret key inside the HSM 23. In the second aspect, the HSM 23 encrypts (wraps) the client secret key with a secret key stored inside the HSM 23 and unique to the HSM 23, and stores the wrapped client secret key in the storage 24. By storing the secret key unique to the HSM 23 inside the HSM 23, the secret key unique to the HSM 23 can be prevented from being leaked outside the HSM 23. As a result, the wrapped client secret key can be prevented from being decrypted and leaked to the outside of the product device 20. In the first example embodiment, any aspect may be adopted.

The storage 24 is a storage device such as a hard disk drive (HDD) or a solid state drive (SSD). The storage 24 stores at least a public key certificate.

The control unit 22 controls hardware included in the product device 20.

The control unit 22 transmits a certificate issuance request to the product device 20 via the communication unit 21. Then, the control unit 22 receives a public key certificate from the product management system 10 via the communication unit 21. The public key certificate includes a public key (hereinafter also referred to as a client public key), a unique ID (UID) that is information for uniquely identifying the product device 20, and a signature of a certificate authority. The client public key is a public key that is paired with a client secret key. The signature of the certificate authority is a signature made using a CA secret key that is a secret key held by the certificate authority, and is a signature indicating that the public key certificate is guaranteed by the certificate authority. The control unit 22 sets a client secret key in the HSM 23 according to the reception of the public key certificate from the product management system 10.

For example, the control unit 22 receives the client secret key generated for the product device 20 by the product management system 10 and the public key certificate from the product management system 10 via the communication unit 21. Then, the control unit 22 stores the client secret key in the HSM 23 and stores the public key certificate in the storage 24.

When the product device 20 is activated, the control unit 22 requests the product management system 10 for connection. Then, the control unit 22 signs authentication data by using the client secret key set in the HSM 23. The authentication data are data shared in a previous sequence with the product management system 10, but may be any data as long as the data are commonly held by the product device 20 and the product management system 10. Then, the control unit 22 transmits an authentication request including the public key certificate stored in the storage 24 and the authentication data to which the signature for the product device 20 is attached to the product management system 10 via the communication unit 21.

When the authentication succeeds, communication is established between the product device 20 and the product management system 10. When there is product history data to be registered in the product management system 10, the control unit 22 transmits the product history data to the product management system 10 via the communication unit 21 after the communication is established.

### [Product Management System 10]

The product management system 10 is a system including one or more computers that manage the product devices 20 in the supply chain. The product management system 10 includes an issuance unit 11, an authentication unit 12, a data registration unit 13, and an output unit 14.

The issuance unit 11 is also referred to as an issuance means. In case of receiving a certificate issuance request from the product device 20, the issuance unit 11 generates a client secret key and a public key certificate for the product device 20.

Then, the issuance unit 11 transmits the client secret key to the product device 20 and stores the client secret key in the HSM 23 of the product device 20. In addition, the issuance unit 11 transmits the public key certificate to the product device 20 and stores the public key certificate in the storage 24 of the product device 20.

Note that the issuance unit 11 includes a certificate authority and holds a CA certificate including a CA public key. The CA public key is a public key that is paired with a CA secret key used by the certificate authority to sign the public key certificate. The CA certificate is a public key certificate corresponding to the CA public key.

The authentication unit 12 is also referred to as an authentication means. In case of receiving an authentication request including the public key certificate and the authentication data to which the signature for the product device 20 is attached from the product device 20, the authentication unit 12 performs authentication as will be described below.

First, the authentication unit 12 acquires the CA certificate from the issuance unit 11, and verifies the public key certificate included in the authentication request using the CA public key included in the CA certificate. For example, when the public key certificate is not guaranteed by the issuance unit 11, the verification of the public key certificate fails. In addition, in a case where some of the public key certificate is falsified, the verification of the public key certificate also fails. As an example, in a case where the UID of the public key certificate is falsified, the verification of the public key certificate fails.

In addition, the authentication unit 12 verifies whether the authentication data are signed with the client secret key that is paired with the client public key by using the client public key in the public key certificate included in the authentication request. For example, in a case where the product device 20 is impersonated or replaced, the verification of the signature fails.

Then, when the verification of the public key certificate included in the authentication request has succeeded and the verification of the signature attached to the authentication data has succeeded, the authentication unit 12 determines that the authentication has succeeded.

The data registration unit 13 is also referred to as a data registration means. The data registration unit 13 registers the product history data of the product device 20 in a data store (not illustrated) in association with the UID of the product device 20. The product history data are data indicating a product history recorded in each process included in the supply chain of the product device 20. The product history data contain at least one of inspection data, inventory management data, distribution management data, verification data at the start of operation, maintenance data, and discard data of the product device 20.

For example, when acquiring product history data from the product device 20 for which authentication has succeeded after the communication is established, the data registration unit 13 registers the product history data of the product device 20 in association with the UID included in the public key certificate of the product device 20.

The output unit 14 is also referred to as an output means. In case of receiving a use start request of the product device 20 from the product device 20 for which authentication has succeeded, the output unit 14 reads product history data registered in association with the UID by using at least the UID included in the public key certificate of the product device 20. Then, the output unit 14 outputs output information related to the read product history data. The output information related to the product history data may be the product history data itself, or may be a report indicating a result of verifying the authenticity of the product device 20 on the basis of the product history data.

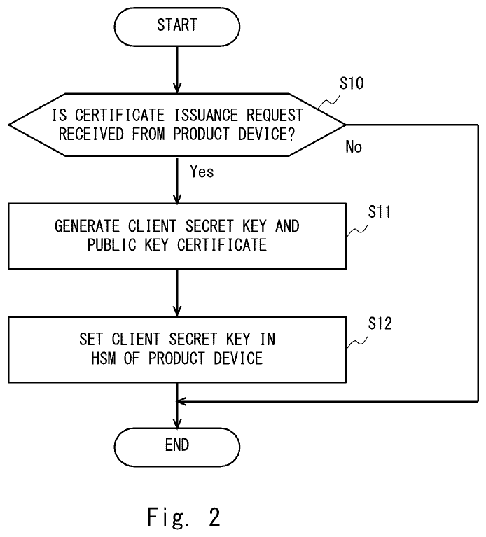

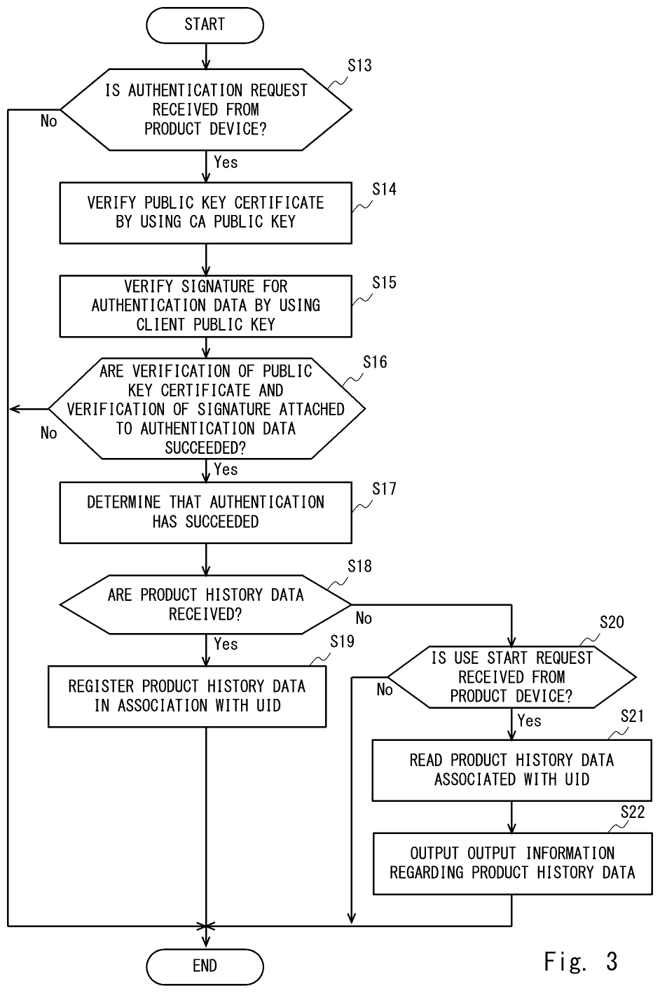

FIGS. 2 and 3 are flowcharts illustrating a flow of product management according to the first example embodiment. First, the product management system 10 determines whether a certificate issuance request is received from the product device 20 (S10). In a case where the certificate issuance request is received (Yes in S10), the issuance unit 11 generates a client secret key and a public key certificate for the product device 20 (S11). Specifically, the issuance unit 11 assigns a UID to the product device 20 and generates a client secret key and a client public key that form a pair. Then, the issuance unit 11 generates a public key certificate including the client public key, the UID of the product device 20, and a signature made by the certificate authority using the CA secret key.

Next, the issuance unit 11 transmits the client secret key generated in S11 to the product device 20, and causes the product device 20 to set the client secret key in the HSM 23 (S12). Then, the product management system 10 ends the process.

Further, the product management system 10 determines whether an authentication request including the public key certificate and authentication data to which a signature for the product device 20 is attached is received from the product device 20 (S13). In a case where no authentication request is received (No in S13), the product management system 10 ends the process. On the other hand, in a case where the authentication request is received (Yes in S13), the authentication unit 12 verifies the public key certificate by using a CA public key included in a CA certificate (S14). This verifies whether the public key certificate is guaranteed by a certificate authority. This also verifies whether the public key certificate has been falsified.

In addition, the authentication unit 12 verifies the signature attached to the authentication data included in the authentication request by using the client public key included in the public key certificate (S15).

Next, the authentication unit 12 determines whether the verification of the public key certificate has succeeded in S14 and the verification of the signature attached to the authentication data has succeeded in S15 (S16). In a case where any of the verifications has failed or both verifications have failed (No in S16), the product management system 10 returns the process to S10 as an authentication failure. On the other hand, in a case where both verifications have succeeded (Yes in S16), the authentication unit 12 determines that the authentication has succeeded (S17).

Next, in a case where the product management system 10 receives product history data from the product device 20 for which authentication has succeeded (Yes in S18), the data registration unit 13 registers the product history data in a data store in association with the UID of the product device 20 (S19). The UID of the product device 20 may be a UID included in the public key certificate. Then, the product management system 10 ends the process.

On the other hand, in a case where receiving a use start request rather than the product history data from the product device 20 for which authentication has succeeded (No in S18, Yes in S20), the product management system 10 advances the process to S21. In S21, the output unit 14 reads the product history data associated with the UID in the data store by using the UID of the product device 20 included in the public key certificate. Then, the output unit 14 outputs output information related to the product history data (S22). On the other hand, in a case where neither the product history data nor the use start request is received (No in S18 and No in S20), the product management system 10 ends the process.

In this manner, according to the first example embodiment, the client secret key of the product device 20 is strictly managed not to be leaked to the outside by the HSM 23 of the product device 20. Therefore, it is guaranteed that the client secret key is stored in the same product device 20 at least until the start of use of the product device 20 after the public key certificate is issued.

Then, the product management system 10 verifies the signature attached to the authentication data at the start of use of the product device 20. As a result, it is possible to guarantee that the product device 20 having the client secret key at the time of issuing the public key certificate is an authentic device without impersonation or replacement.

In addition, the product management system 10 verifies the public key certificate of the product device 20 at the start of use of the product device 20. As a result, it is possible to guarantee the origin of the public key certificate of the product device 20, and guarantee that the content of the public key certificate, particularly the UID, has not been falsified.

Furthermore, only for a device of which the authenticity is guaranteed at the start of use of the product device 20 and which has an authentic public key certificate, the product management system 10 can read a product history associated with the UID of the device, and trace the product history. As a result, it is possible to broadly guarantee the authenticity of the product device 20 in the supply chain so far at the start of use.

Note that although the public key certificate and the signed authentication data are included in the authentication request, they may not be included in the authentication request. For example, the product management system 10 may receive the public key certificate and the signed authentication data separately from the authentication request. In addition, the reception of the public key certificate and the signed authentication data may be regarded as receiving the authentication request, thereby omitting the reception of the authentication request.

In the first example embodiment described above, the product management system 10 generates a pair of client secret keys and distributes the pair of client secret keys to the product device 20. Alternatively, the product device 20 may generate a client secret key instead of the product management system 10. In this case, the product device 20 may generate a client public key that is paired with the client secret key, and transmit the client public key to the product management system 10 upon a certificate issuance request. The product management system 10 that received the client public key may assign a UID and generate a public key certificate. Then, the product management system 10 may reply to the product device 20 with the public key certificate and request the product device 20 to set the client secret key in the HSM 23. According to this method, since the client secret key is not placed on the network, the client secret key can be managed more securely.

### Second Example Embodiment

Next, a second example embodiment of the present disclosure will be described. In the second example embodiment, a universally unique identifier (UUID) is used as an example of the UID.

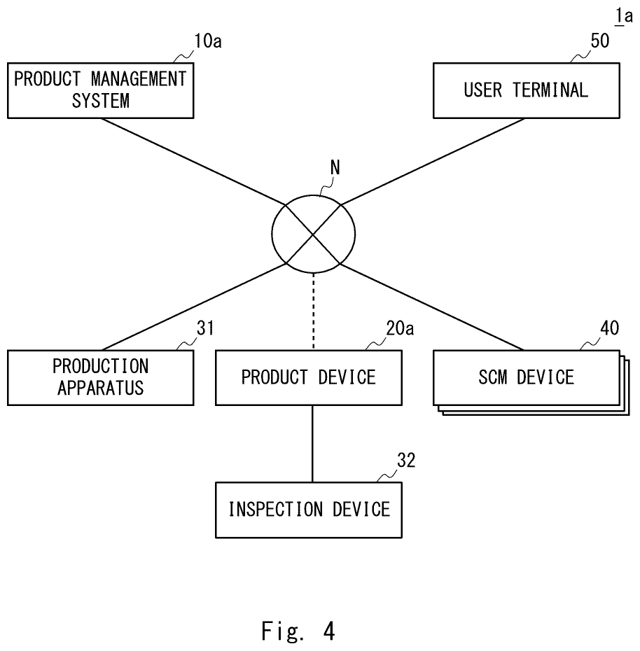

FIG. 4 is a block diagram illustrating a configuration of a system la according to the second example embodiment. The system 1a is a specific example of the system 1. The system 1a includes a product device 20a, a product management system 10a, a production apparatus 31, an inspection device 32, one or more SCM devices 40, and a user terminal 50. The product management system 10a, the production apparatus 31, and one or more SCM devices 40 are connected to a network N. The network N is a wired or wireless communication network.

The product device 20a corresponds to the product device 20 of the first example embodiment, and is equipped with a trusted platform module (TPM) is implemented as an example of the HSM. The product device 20a is connected to the network N in a power-on state (activated state), and is disconnected from the network N in a power-off state (stopped state). In the second example embodiment, the aspect in which the client secret key is managed by the TPM of the product device 20a takes the first aspect described in the first example embodiment, but may take the second mode.

The product management system 10a corresponds to the product management system 10 of the first example embodiment. The production apparatus 31 is an apparatus that produces the product device 20a. The inspection device 32 is a device that inspects the produced product device 20a.

The SCM device 40 is a device that manages the product device 20 in a supply chain other than the production and the inspection. For example, the SCM device 40 is a computer connected to a handy terminal used in a warehouse or during distribution. In the second example embodiment, the SCM device 40 is equipped with an HSM, e.g., a TPM, similarly to the product device 20a. Then, the SCM device 40 stores a client secret key generated for the SCM device 40 in the TPM of the SCM device 40. In the second example embodiment, the aspect in which the client secret key is managed by the TPM of the SCM device 40 is similar to the first aspect described in the first example embodiment, but may be similar to the second aspect.

The user terminal 50 is a terminal used by a person (user) who uses the product device 20a in operation. For example, the user terminal 50 is a personal computer, a smartphone, or the like.

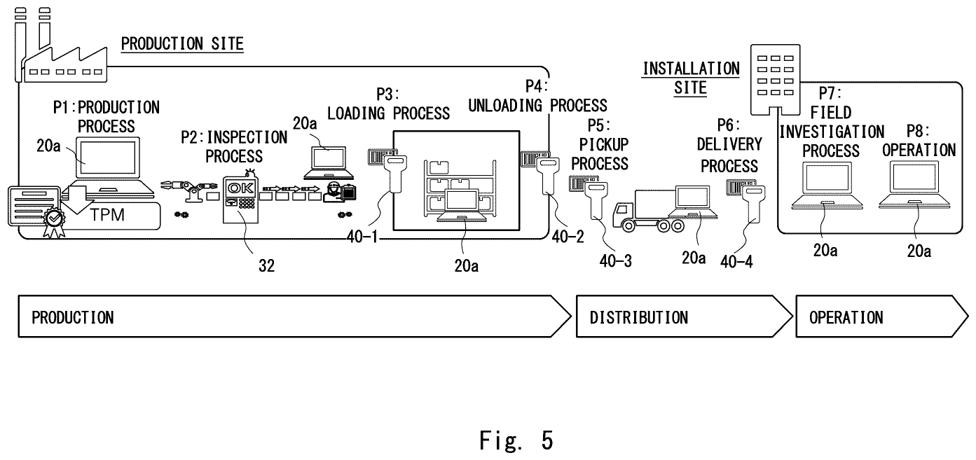

FIG. 5 is a diagram schematically illustrating a supply chain. The supply chain is mainly divided into production, distribution, and operation. The production includes four processes including a production process (P1), an inspection process (P2), a warehouse loading process (P3), and an unloading process (P4). The distribution includes two processes including a pickup process (P5) and a delivery process (P6). The operation includes a field investigation process (P7) and a subsequent operation process (P8). The product management system 10a collects product history data in each process from the product device 20a or the SCM device 40, and records the product history data in association with the UID of the product device 20a.

First, in the production process (P1), the product device 20a is in an activated state. At this time, the product device 20a receives a client secret key generated for the product device 20a from the product management system 10a, and stores the client secret key in its TPM.

Next, in the inspection process (P2), the product device 20a is also in the activated state. First, the product device 20a signs product history data such as a result of an inspection performed by the inspection device 32 with the client secret key stored in its TPM. Then, the product device 20a accesses the product management system 10a using a UUID included in its public key certificate as an identifier. The product management system 10a performs authentication to be described below, and confirms that the access is from an authentic device having a client secret key when the product management system 10a itself issues a public key certificate. When the authentication has succeeded, the product device 20a registers the product history data in the product management system 10a in association with the UID of the product device 20a.

Then, the product device 20a is packaged, and thereafter, the product device 20a is in a stopped state in the loading process (P3), the unloading process (P4), the pickup process (P5), and the delivery process (P6). Therefore, the SCM device 40 is authenticated instead of the product device 20a, and the product history data are registered in the product management system 10a. At this time, the SCM device 40 accesses the product management system 10a, and is authenticated using the client secret key stored in its TPM in the same manner as the product device 20a in P2.

Here, the UUID of the product device 20a is used to associate the product history data with the product device 20a in P2, but it is difficult to read the UUID from the product device 20a that is in a stopped state in P3 to P6. Therefore, in P3 to P6, a substitute ID capable of specifying the UUID of the product device 20a is used instead of the UUID of the product device 20a for the association. The substitute ID may be at least one of a model number, a serial number (S/N), and a distribution slip number of the product device 20a, or a combination thereof.

The SCM device 40 for which authentication has succeeded registers product history data such as distribution management data in the product management system 10a in association with the substitute ID of the product device 20.

Then, after the product device 20a is delivered to the user, the product device 20a is powered on in the field investigation process (P7) at the start of use. The activated product device 20a accesses the product management system 10a and is authenticated in the same way as in P2.

When the authentication has succeeded, the product management system 10a traces information associated with the UUID or the substitute ID of the product device 20a, and collects product history data related to production, inspection, loading, and unloading in a factory and pickup and delivery during distribution, including a device verification result at the time of field investigation. Then, the product management system 10a verifies whether all of the product history data indicates a normal history. The normal history may be, for example, passing an inspection or performing various works appropriately. When all of the product history data indicates a normal history, it is determined that the product device 20a is an authentic device without fake inspection statement, falsification, replacement or impersonation throughout the supply chain. Then, the product management system 10a collects verification results in a report and transmits the report to the user terminal 50.

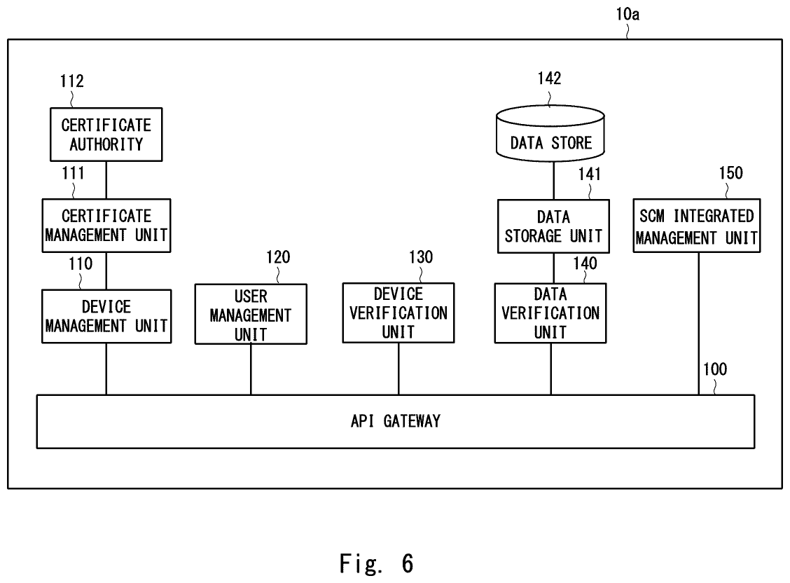

FIG. 6 is a block diagram illustrating a configuration of the product management system 10a according to the second example embodiment. The product management system 10a includes an API gateway 100, a device management unit 110, a certificate management unit 111, a certificate authority 112, a user management unit 120, a device verification unit 130, a data verification unit 140, a data storage unit 141, a data store 142, and an SCM integrated management unit 150. Hereinafter, a device that accesses the product management system 10a will be referred to as a client.

The API gateway 100 relays communication between a client and another element of the product management system 10a. For example, the API gateway 100 transmits a request received from the client to another element of the product management system 10a. Then, the API gateway 100 transmits a response received from another element to the client.

The device management unit 110, the certificate management unit 111, and the certificate authority 112 correspond to the issuance unit 11 of the first example embodiment.

In case of receiving a public key certificate issuance request from a client via the API gateway 100, the device management unit 110 assigns a UUID to the client. The public key certificate issuance request corresponds to the certificate issuance request of the first example embodiment. The device management unit 110 registers the newly assigned UUID in a device database (not illustrated) in association with a substitute ID such as an S/N or a model number of the client.

In case of receiving a public key certificate issuance request from a client via the API gateway 100, the certificate authority 112 generates a client secret key and a client public key for the client. Then, the certificate authority 112 generates a public key certificate including the client public key and the UUID assigned by the device management unit 110, and makes a signature with a CA secret key held by the certificate authority 112. This signature is also referred to as a CA signature. Then, the certificate authority 112 distributes the generated client secret key and public key certificate to the client via the API gateway 100.

The certificate authority 112 also issues a CA certificate. The CA certificate includes a CA public key that is paired with the CA secret key used for the CA signature.

The certificate management unit 111 manages the public key certificate distributed to each client.

The user management unit 120 manages IDs of devices and persons related to the system 1. For example, the user management unit 120 manages an ID of a person who works in each process for production, distribution, or the like. In addition, for example, the user management unit 120 manages the product device 20a and the user who purchases and operates the product device 20a in association with each other. Specifically, the user management unit 120 manages the UUID of the product device 20a assigned by the device management unit 110 and the address of the user terminal 50 in association with each other.

The device verification unit 130 corresponds to the authentication unit 12 of the first example embodiment. The device verification unit 130 performs authentication in case of receiving an authentication request from a client. The authentication performed by the device verification unit 130 includes device verification in addition to client certificate verification corresponding to the authentication of the first example embodiment. The authentication request includes at least a public key certificate for the client, signed authentication data, and a UUID or a substitute ID of the product device 20a. In the second example embodiment, data shared in a previous sequence between the product management system 10a and the client is used as the authentication data. When the UUID of the product device 20a is included in the public key certificate included in the authentication request, the UUID of the product device 20a may not be separately included in the authentication request.

The client certificate verification is performed for communication path establishment. The client certificate verification includes verification of the public key certificate and verification of the signature attached to the authentication data described in the first example embodiment. When the verification of the public key certificate has succeeded and the verification of the signature attached to the authentication data has succeeded, the client certificate verification succeeds.

The device verification is a process of verifying whether the UUID included in the public key certificate is an UUID registered in the device database.

In the second example embodiment, the device verification unit 130 determines that the authentication has succeeded in a case where the client certificate verification has succeeded and the device verification has succeeded. On the other hand, when one or both of the verifications have failed, the device verification unit 130 determines that the authentication has failed. As a result, the product management system 10a can confirm that the access is from an authentic device to which the product management system 10a itself has transmitted the client secret key.

When the client certificate verification has succeeded, communication between the product management system 10a and the client is established. Thereafter, in case of receiving product history data to which the signature for the client is attached from the client for which authentication has succeeded, the device verification unit 130 supplies the product history data to which the signature is attached to the data storage unit 141.

The data storage unit 141 corresponds to the data registration unit 13 of the first example embodiment. The data storage unit 141 registers (records) the product history data provided by the client for which authentication has succeeded in the data store 142 in association with the UUID or the substitute ID of the product device 20a. It is possible to prevent impersonation of the client and fake data by treating only the product history data provided by the client for which authentication has succeeded as authentic product history data.

The data store 142 corresponds to the data store of the first example embodiment.

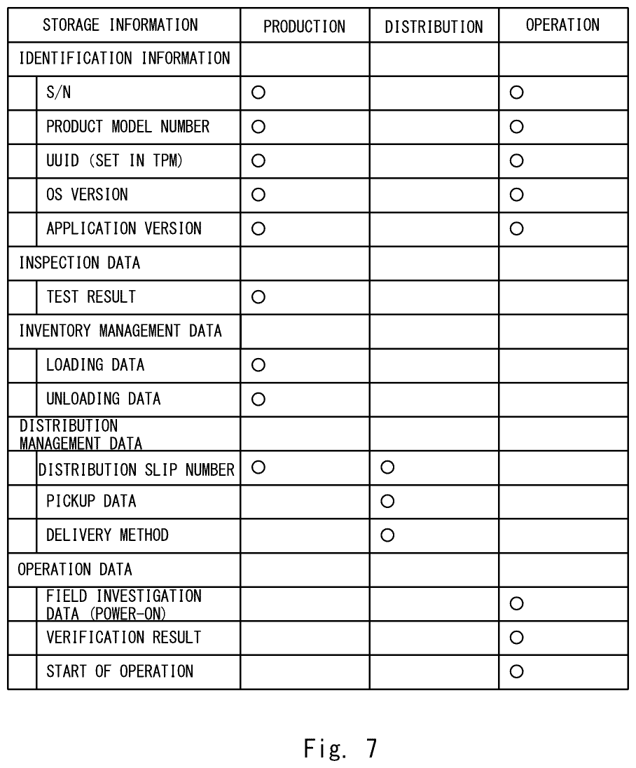

FIG. 7 is a diagram for explaining data recorded in the data store 142. In the data store 142, identification information of the product device 20a and product history data are recorded. The product history data contain inspection data, inventory management data, distribution management data, and operation data.

The type of data recorded in the data store 142 varies depending on the process of the supply chain. For example, in P2 to P4 for production, the data storage unit 141 records one type of identification information of the product device 20a and the inspection data or the inventory management data in association with each other.

Examples of the identification information of the product device 20a include an S/N, a model number, a UUID, an OS version, and an application version. The identification information other than the UUID is not capable of uniquely identifying the product device 20a if the identification information is one type of identification information, and is capable of uniquely identifying the product device 20a if the identification information is a combination of two or more types of identification information. This combination is a substitute ID. For example, in P3 to P5 in which the UUID cannot be acquired because the product device 20a has been packaged but other identification information can be acquired, the data storage unit 141 records the S/N and the model number as the identification information of the product device 20a.

In P4 at the time of unloading, a distribution slip number of the distribution management data is recorded in addition to the data described above.

In addition, in P5 and P6 for distribution, the data storage unit 141 records a distribution slip number, pickup data, and a pickup method in association with each other as the distribution management data. In P5 and P6 in which the identification information of the product device 20a cannot be acquired, the distribution slip number is a substitute ID for identifying the product device 20a.

In P7 and P8 for operation, the data storage unit 141 records one type of identification information of the product device 20a and operation data in association with each other. The operation data contain field investigation data indicating a result of the field investigation performed in P7, a result of verification performed by the data verification unit 140 at the time of field investigation, and data indicating that the operation has started.

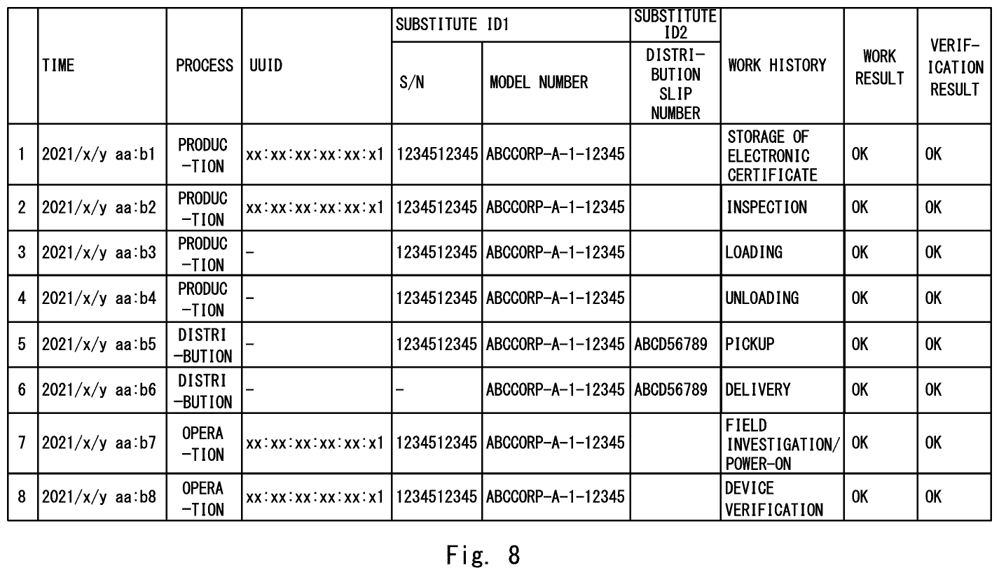

FIG. 8 is a diagram illustrating an example of a data structure in the data store 142. As an example, a time, a process name, a UUID, a substitute ID, a type of work history, and a work result are recorded in the data store 142. As an example, substitute ID 1 is an S/N and a model number. Further, substitute ID 2 is a distribution slip number. The time, the process name, the type of work history, the work result, and the verification result are examples of product history data.

If the substitute ID is recorded in a process in which the UUID is not recorded as well as a process in which the UUID is recorded, the product history of the product device 20a can be traced.

Returning to FIG. 6, the description will be continued. In case of receiving a use start request from the client for which authentication has succeeded, the data verification unit 140 reads the product history data associated with the UUID or the substitute ID of the client and the signature thereon from the data store 142. Then, the data verification unit 140 verifies the signature on the product history data using the client public key of the public key certificate. As a result, it is possible to confirm that the product history data has not been falsified between the time when the product history data are stored and the time when the product history data are read. In a case where the verification of the signature on the product history data has succeeded and it has been confirmed that the product history data has not been falsified, the data verification unit 140 verifies whether each piece of the read product history data indicates a normal history. Then, the data verification unit 140 supplies the read product history data and each verification result to the SCM integrated management unit 150 via the API gateway 100.

The SCM integrated management unit 150 corresponds to the output unit 14 of the first example embodiment. The SCM integrated management unit 150 generates and outputs a report indicating the verification result. Then, the SCM integrated management unit 150 transmits the report to the user terminal 50 of the user who operates the product device 20a. As a result, the user who has purchased the product device 20a can confirm that the product device 20a has arrived at hand in an authentic state before the start of operation, and thus, it is possible to guarantee that a device is used in operation without impersonation or replacement of the device. Then, it is possible to eliminate a security accident in which an unauthentic device is used in operation.

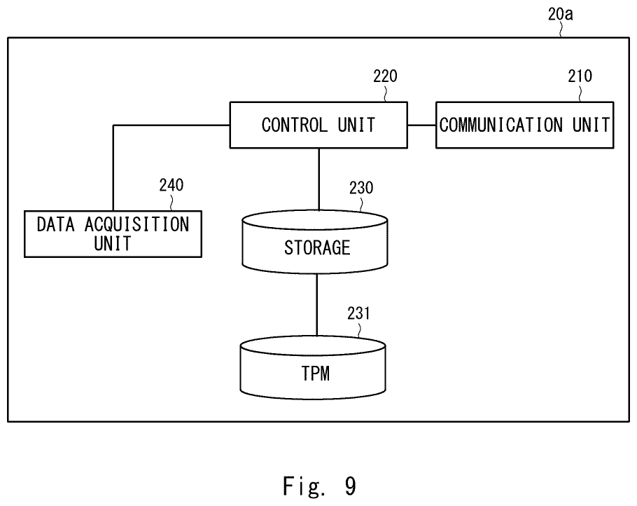

FIG. 9 is a block diagram illustrating a configuration of the product device 20a according to the second example embodiment. The product device 20a includes a communication unit 210, a control unit 220, a storage 230, a TPM 231, and a data acquisition unit 240.

The communication unit 210 is an example of the communication unit 21 of the first example embodiment. The communication unit 210 is a communication interface for connection to the network N.

The control unit 220 is an example of the control unit 22 of the first example embodiment. The control unit 220 controls hardware included in the product device 20a.

The storage 230 is an example of the storage 24 of the first example embodiment. The TPM 231 is an example of the HSM 23 of the first example embodiment, and stores and manages a client secret key distributed to the product device 20a. The TPM 231 is mounted on a motherboard or the like. The data acquisition unit 240 acquires data regarding a product history. For example, the data acquisition unit 240 acquires sensing data from a sensor. Alternatively, the data acquisition unit 240 receives an input of inspection data from an inspection apparatus. Alternatively, the data acquisition unit 240 acquires inspection data from the inspection device 32. The product history data are generated by the control unit 220 based on the data regarding the product history acquired by the data acquisition unit 240.

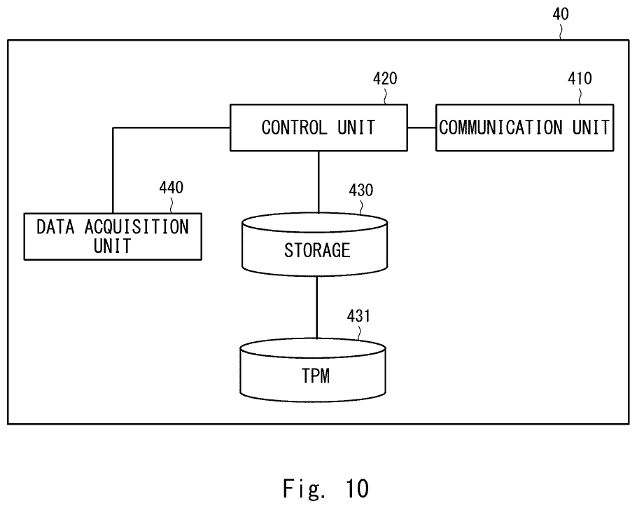

FIG. 10 is a block diagram illustrating a configuration of the SCM device 40 according to the second example embodiment. The SCM device 40 includes a communication unit 410, a control unit 420, a storage 430, a TPM 431, and a data acquisition unit 440.

The communication unit 410 is a communication interface for connection to the network N.

The control unit 420 controls hardware included in the SCM device 40.

The storage 430 is a storage device such as an HDD or an SSD. The storage 430 stores a public key certificate distributed to the SCM device 40.

The TPM 431 is an example of the HSM that stores and manages a client secret key distributed to the SCM device 40. The TPM 431 has tamper resistance. The TPM 431 is mounted on a motherboard or the like.

The data acquisition unit 440 acquires data regarding a product history. For example, the data acquisition unit 440 receives an input of inventory management data or distribution management data from an operator. Alternatively, the data acquisition unit 440 reads data such as a distribution slip number from an IC tag, a barcode, or a two-dimensional code attached to the packaged product device 20a. The product history data are generated by the control unit 420 based on the data regarding the product history acquired by the data acquisition unit 440.

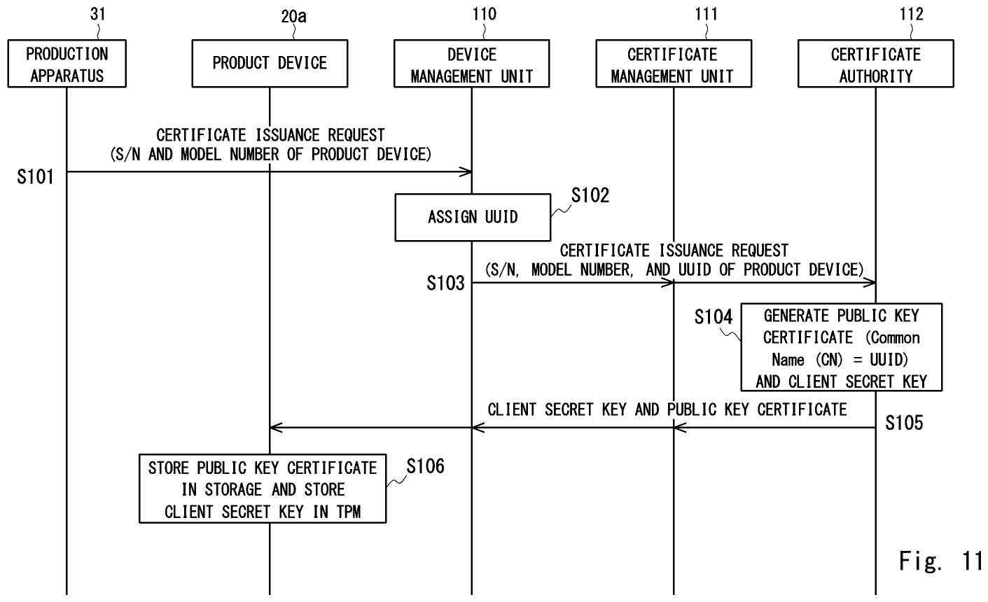

FIG. 11 is a sequence diagram illustrating an example of a flow of certificate issuance for a product device in the production process (P1) according to the second example embodiment. First, the production apparatus 31 that has produced the product device 20a transmits a certificate issuance request for the product device 20a to the product management system 10a (S101). At this time, an S/N and a model number of the product device 20a are included in the certificate issuance request.

The device management unit 110 that received the certificate issuance request via the API gateway 100 assigns a UUID to the product device 20a (S102). Then, the device management unit 110 supplies the received certificate issuance request in which the UUID is included to the certificate authority 112 (S103).

The certificate authority 112 generates a client secret key and a client public key, and generates a public key certificate for which the UUID is a common name (CN) (S104). The certificate authority 112 adds a CA signature to the public key certificate using a CA secret key. Then, the certificate authority 112 distributes the client secret key and the public key certificate to the product device 20a via the certificate management unit 111, the device management unit 110, and the API gateway 100 (S105).

The product device 20a stores the public key certificate in the storage 230, and stores the client secret key in the TPM 231 (S106).

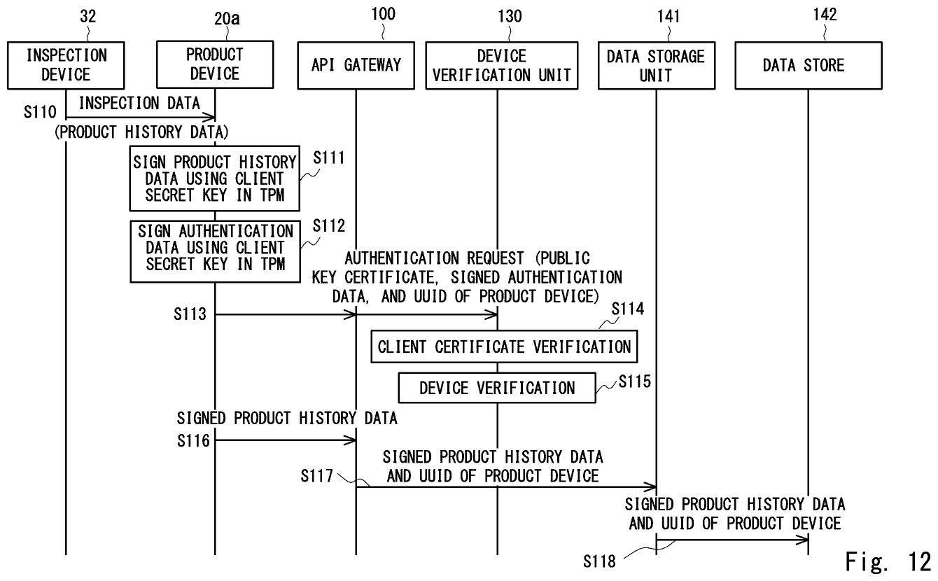

FIG. 12 is a sequence diagram illustrating an example of a flow of product management in the inspection process (P2) according to the second example embodiment. First, the inspection device 32 transmits inspection data as product history data to the product device 20a (S110).

Next, the product device 20a signs the product history data using the client secret key stored in the TPM 231 (S111). Next, the product device 20a signs authentication data necessary for establishing a communication path using the client secret key stored in the TPM 231 (S112). Then, the product device 20a transmits an authentication request to the device verification unit 130 via the API gateway 100 (S113). At this time, the authentication request includes the signed authentication data, the public key certificate stored in the storage 230, and the UUID set in the public key certificate. The product device 20a may transmit these information to the device verification unit 130 separately from the authentication request.

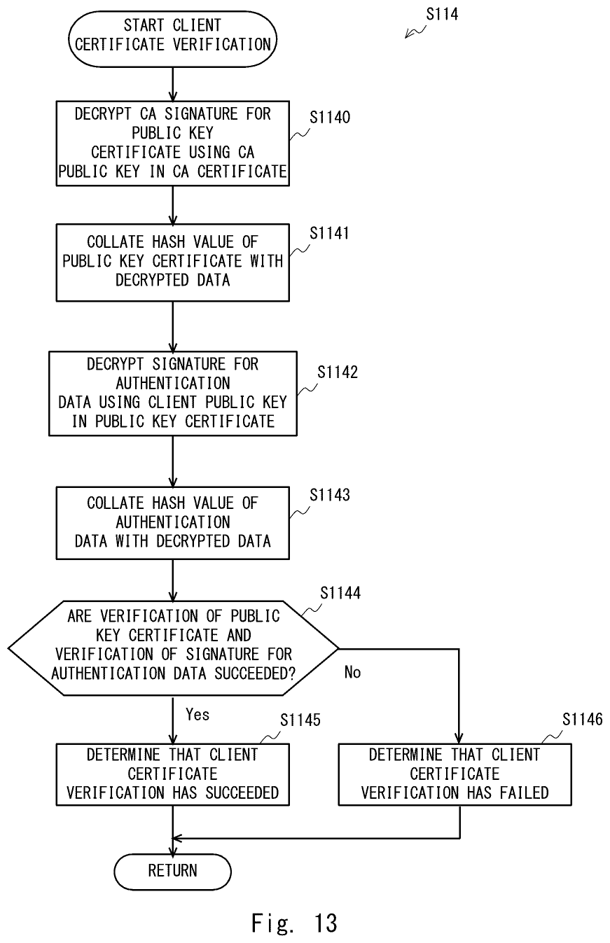

The device verification unit 130 executes client certificate verification (S114). S114 will be described in detail with reference to FIG. 13. In addition, the device verification unit 130 executes device verification and verifies whether the UUID is registered in the device database (S115). Here, it is assumed that the client certificate verification has succeeded and the device verification has succeeded.

When the client certificate verification has succeeded, communication is established between the product device 20a and the product management system 10a. Then, the product device 20a transmits the signed product history data to the product management system 10a using the established communication path (S116).

Since the authentication has succeeded in the present example, the data storage unit 141 receives the signed product history data and the UUID of the product device 20a via the API gateway 100 (S117).

The data storage unit 141 records the signed product history data in the data store 142 in association with the UUID of the product device 20a (S118).

FIG. 13 is a flowchart illustrating an example of a flow of client certificate verification (S114 in FIG. 12) according to the second example embodiment. First, the device verification unit 130 verifies the public key certificate included in the authentication request. Specifically, the device verification unit 130 decrypts the CA signature attached to the public key certificate using the CA public key included in the CA certificate (S1140). Then, the device verification unit 130 calculates a hash value of the public key certificate and collates the hash value with the data (plain text) decrypted in S1140 (S1141). As a result, it is possible to confirm that the public key certificate is guaranteed by the certificate authority 112 and that the public key certificate has not been falsified.

Next, the device verification unit 130 verifies the signature attached to the authentication data included in the authentication request. The device verification unit 130 decrypts the signature added to the authentication data included in the authentication request by using the client public key included in the public key certificate (S1142). Then, the device verification unit 130 calculates a hash value of the authentication data, and collates the hash value with the signature data (plain text) decrypted in S1142 (S1143). As a result, the authentication source client can verify whether it is a device to which the product management system 10a has delivered a client secret key.

Then, the device verification unit 130 determines whether the verification of the public key certificate in S1141 has succeeded and the verification of the signature in S1143 has succeeded (S1144). If both of the verifications have succeeded (Yes in S1144), the device verification unit 130 determines that the client certificate verification has succeeded (S1145). On the other hand, when one or both of the verifications have failed, the device verification unit 130 determines that the client certificate verification has failed (S1146).

Note that S112 to S114 in FIG. 12 represent some of the typical processes in general client certificate verification for establishing a communication path, but another process generally performed in client certificate verification may be performed in S112 to S114 or before or after S112 to S114.

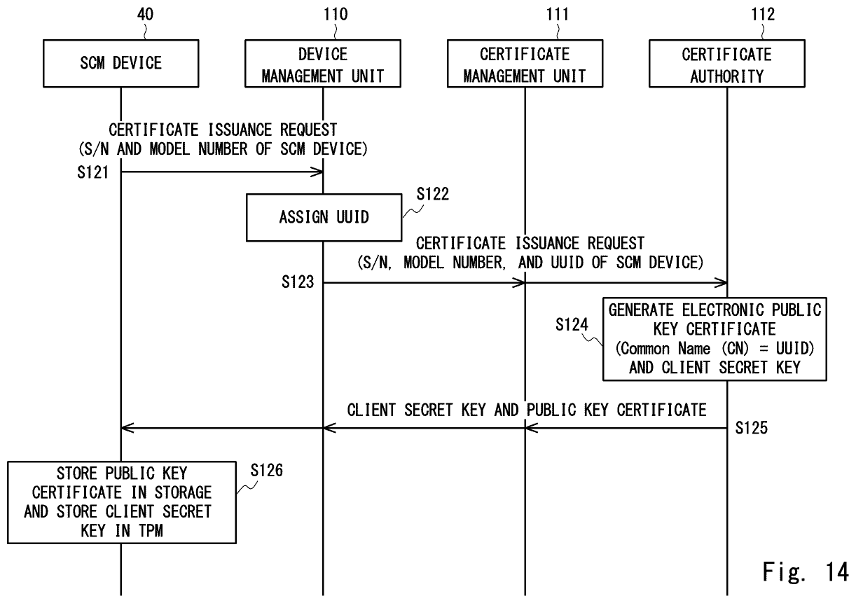

FIG. 14 is a sequence diagram illustrating an example of a flow of certificate issuance for the SCM device 40 according to the second example embodiment. This certificate issuance is performed before the product device 20a reaches the process.

First, the SCM device 40 transmits a certificate issuance request for the SCM device 40 to the product management system 10a (S121). At this time, an S/N and a model number of the SCM device 40 are included in the certificate issuance request. The product management system 10a that received the certificate issuance request via the API gateway 100 executes processes on the SCM device 40 in S122 to S126 similar to those in S102 to S106.

As a result, the client secret key distributed to the SCM device 40 is stored in the TPM 431 of the SCM device 40, and the public key certificate distributed to the SCM device 40 is stored in the storage 430 of the SCM device 40.

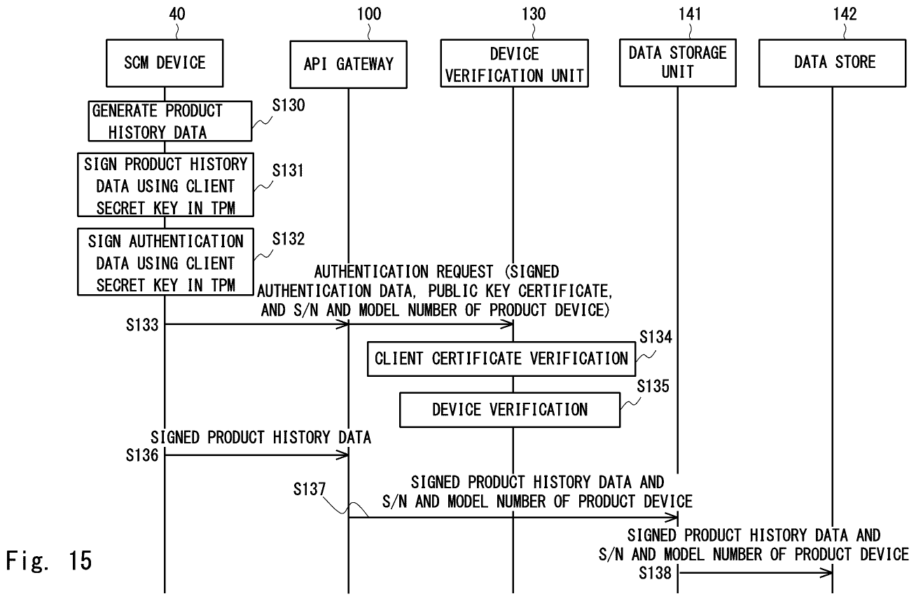

FIG. 15 is a sequence diagram illustrating an example of a flow of product management in processes, for example, loading and unloading processes (P3 and P4), after packaging according to the second example embodiment. First, the control unit 420 of the SCM device 40 acquires data regarding a product history from the data acquisition unit 440, and generates product history data on the basis of the acquired data (S130). Then, the control unit 420 of the SCM device 40 signs the product history data using the client secret key stored in the TPM 431 (S131). Next, the SCM device 40 signs the authentication data necessary for establishing a communication path using the client secret key stored in the TPM 431 (S132). Then, the SCM device 40 transmits an authentication request to the device verification unit 130 via the API gateway 100 (S133). At this time, the authentication request includes the signed authentication data, the public key certificate stored in the storage 430, and the substitute ID of the product device 20a. As an example, in FIG. 15, the substitute ID of the product device 20a is an S/N and a model number of the product device 20a.

Similarly to S114, the device verification unit 130 executes client certificate verification (S134). In addition, the device verification unit 130 executes device verification, and determines whether the substitute ID is registered in the device database (S135). Here, it is assumed that the client certificate verification has succeeded and the device verification has succeeded.

When the client certificate verification has succeeded, communication is established between the SCM device 40 and the product management system 10a. Then, the product device 20a transmits the signed product history data from the SCM device 40 to the product management system 10a using the established communication path (S136).

Since the authentication has succeeded in the present example, the data storage unit 141 receives the signed product history data and the substitute ID of the product device 20a via the API gateway 100 (S137).

The data storage unit 141 records the signed product history data in the data store 142 in association with the substitute ID of the product device 20a (S138).

In this manner, when the product device 20a is in a stopped state, it is possible to prevent fake product history statement by treating only the product history data provided by the SCM device 40 for which verification has succeeded by the device verification unit 130 as authentic product history data.

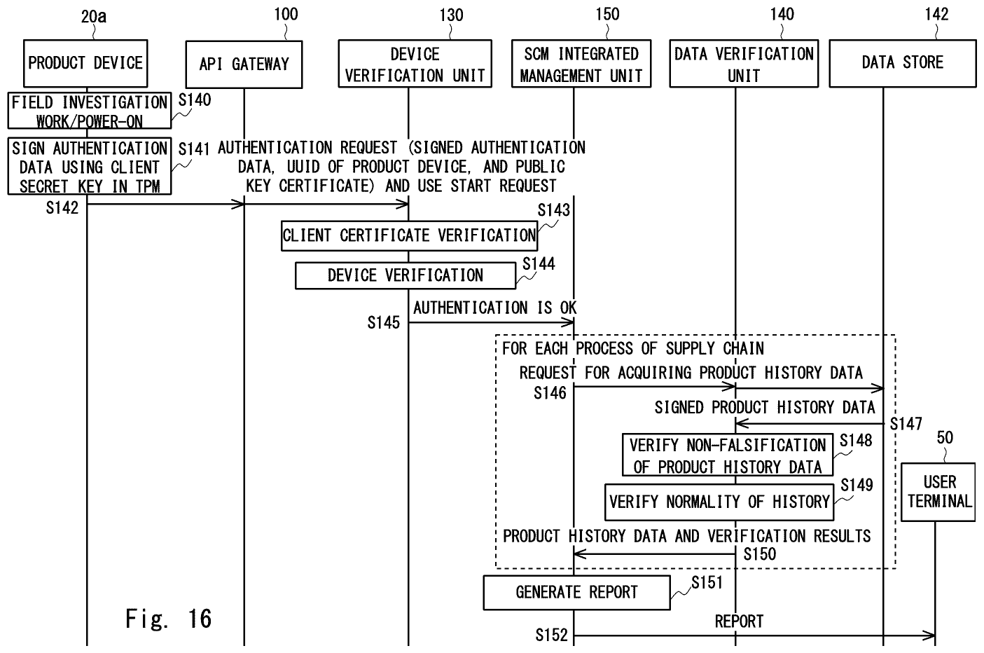

FIG. 16 is a sequence diagram illustrating an example of a flow of data verification in the field investigation process (P7) according to the second example embodiment. After the product device 20a is delivered to the user, the power of the product device 20a is powered on at the start of operation to perform field investigation work (S140). At this time, the product device 20a signs the authentication data using the client secret key stored in the TPM 231 (S141). Then, the product device 20a accesses the product management system 10a, and transmits a use start request together with an authentication request (S142). The authentication request includes the signed authentication data, the public key certificate stored in the storage 230, and the UUID set in the public key certificate.

The product management system 10a that received the certificate issuance request via the API gateway 100 executes client certificate verification and device verification in S114 and S115 similar to those in S143 and S144. Here, it is assumed that the client certificate verification has succeeded and the device verification has succeeded. In this case, the device verification unit 130 notifies the SCM integrated management unit 150 that the authentication has succeeded (S145).

Next, S146 to S150 are performed on product history data for each process of the supply chain. First, in S146, the SCM integrated management unit 150 requests the data verification unit 140 to acquire product history data. Then, in S147, for a process in which the UUID has been recorded, the data verification unit 140 reads the signed product history data registered in association with the UUID from the data store 142. On the other hand, for a process in which the UUID has not been recorded, the data verification unit 140 reads the signed product history data registered in association with the substitute ID specifying the UUID from the data store 142. Then, in S148, the data verification unit 140 verifies the non-falsification of the product history data using the client public key of the public key certificate. Specifically, the data verification unit 140 verifies whether the product history data has been falsified by collating data obtained by decrypting the signature attached to the product history data with a hash value of the product history data. Here, it is assumed that the verification of the non-falsification of the product history data has succeeded. In this case, in S149, the data verification unit 140 verifies whether the read product history data indicate a normal history. For example, when the work result included in the product history data is OK, it is determined that the read product history data indicate a normal history. Then, the data verification unit 140 supplies the product history data and the verification results of S148 to S149 to the SCM integrated management unit 150 (S150).

The SCM integrated management unit 150 generates a report indicating the verification results (S151). Then, the SCM integrated management unit 150 transmits the generated report to the user terminal 50 (S152).

In this manner, the second example embodiment has the same effects as those of the first example embodiment. Further, in the second example embodiment, when the product device 20a is in a stopped state, the SCM device 40 serves as a substitute to register product history data. The product management system 10a records, in the data store, only the product history data provided by the SCM device 40 to which the product management system 10a itself has delivered the client secret key, as authentic data. As a result, fake data can be prevented.

When the product device 20a is in a stopped state, the product management system 10a records the product history data in association with the substitute ID. As a result, authentic product history data can be recorded throughout the supply chain.

Note that it has been mentioned so far that it is possible to confirm whether the product device 20a unloaded from the factory has reached the user while maintaining its authenticity. However, since there is a possibility that the TPM 231 having a one-to-one correspondence with the UUID is replaced by on-site maintenance, it is also necessary to consider processes after the start of operation, such as maintenance and discard.

For example, a case where a motherboard (MB) on which a TPM 231 is mounted is replaced by on-site maintenance may be considered. In this case, a maintenance worker replaces the MB equipped with the TPM 231 as a faulty product with a new MB. Specifically, when the maintenance worker uses a dedicated tool, the product device 20a equipped with the new MB transmits a certificate issuance request to the product management system 10a. The product management system 10a newly generates a public key certificate and a client secret key for the product device 20a, and delivers the public key certificate and the client secret key to the product device 20a. As a result, the new client secret key is stored in a new TPM 231.

For the faulty product, processes of deletion and revocation of the public key certificate are required. This is to prevent access to the product management system 10a using the MB of the faulty TPM 231 again. When the power is not turned on, only a process of revocation of the public key certificate may be performed. Then, the faulty product is physically destroyed and discarded.

Note that product history data in processes after the start of operation, such as maintenance and discard, may also be recorded in the data store 142 in the same manner as that in the other processes.

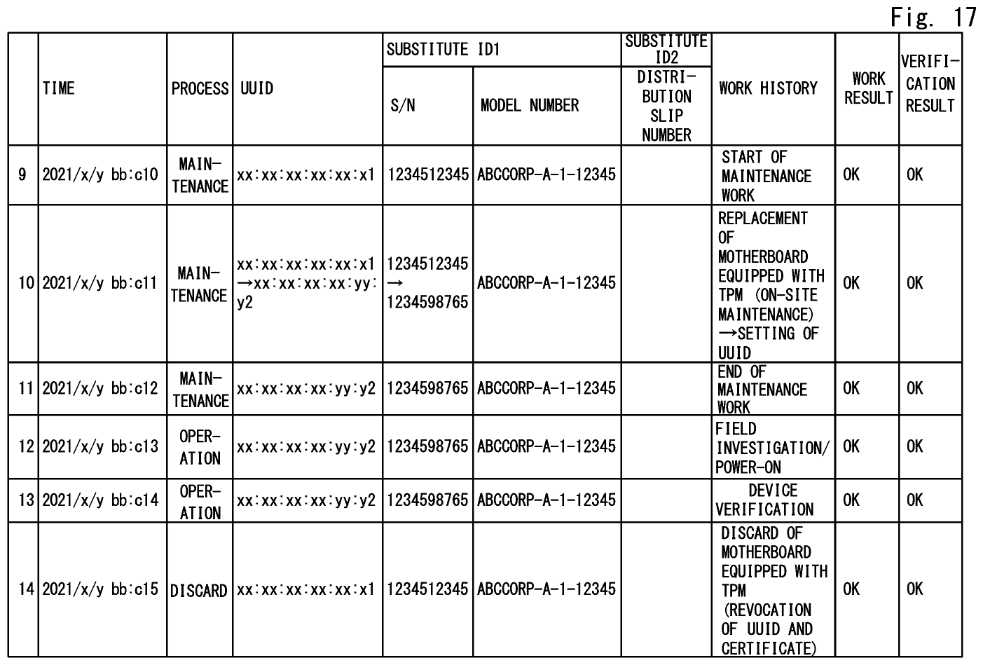

FIG. 17 is a diagram illustrating an example of a data structure in the data store 142 including production history data related to maintenance and discard. As illustrated in a record on the 10th line of FIG. 17, since the TPM 231 has been replaced, the UUID has been changed, and the S/N has also been changed. In addition, as illustrated in a record on the 14th line of FIG. 17, a revocation process is performed on the UUID of the old TPM 231 and the old public key certificate.

In this manner, the product management system 10a can also manage product history data for processes after the start of operation such as maintenance and discard.

### Third Example Embodiment

Next, a third example embodiment of the present disclosure will be described. In the second example embodiment, the product management system records product history data in the data store. However, in the third example embodiment, the product management system uses a blockchain in addition to the data store in order to reduce a falsification risk when product history data are shared among a plurality of different interested parties.

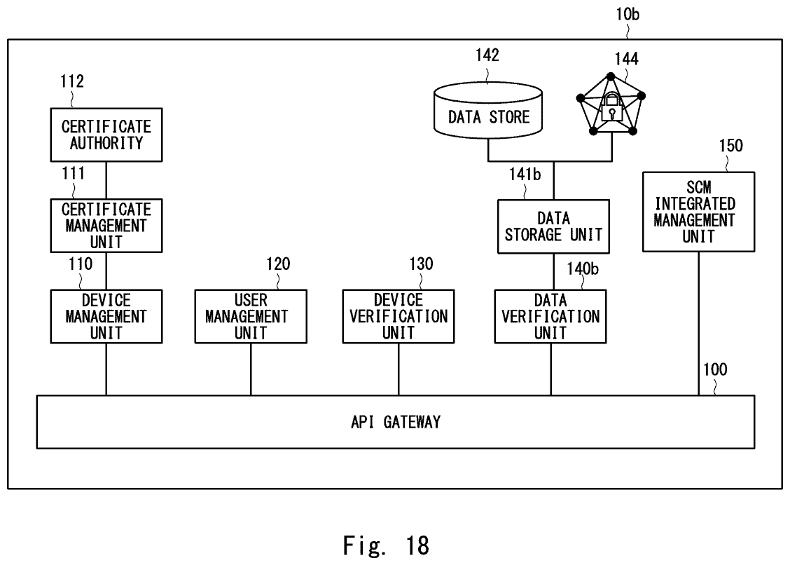

FIG. 18 is a block diagram illustrating a configuration of a product management system 10b according to the third example embodiment.

The product management system 10b has configurations and functions basically similar to those of the product management system 10a of the second example embodiment. However, the product management system 10b is different from the product management system 10a by including a data storage unit 141b and a data verification unit 140b instead of the data storage unit 141 and the data verification unit 140, and a blockchain 144.

Similarly to the data storage unit 141, the data storage unit 141b registers the product history data and the signature thereon in the data store. At this time, the data storage unit 141b calculates a hash value of the product history data and stores the hash value in the blockchain 144.

Similarly to the data verification unit 140, the data verification unit 140b reads product history data. At this time, the data verification unit 140b verifies a block corresponding to the read product history data in the blockchain 144. Specifically, the data verification unit 140b verifies the block by collating a hash value recorded in the block with the hash value of the product history data, in addition to the block verification known in the blockchain technology. Then, when the verification of the normality of the product history data has succeeded and the verification of the block has succeeded, the data verification unit 140b determines that there is no fake, falsification, or replacement of the product history data of the product device 20a through the supply chain.

Then, the SCM integrated management unit 150 generates a report on various verification results including the verification result of the block and sends the report to the user terminal 50.

In this manner, according to the third example embodiment, it is possible to suitably reduce a falsification risk when product history data are shared among a plurality of different interested parties.

Note that the present disclosure is not limited to the example embodiments described above, and can be appropriately changed without departing from the scope. For example, in the second and third example embodiments described above, the inspection device 32 is treated as a device separate from the SCM device 40, but the inspection device 32 may also be included in the SCM device 40.

Further, in the second and third example embodiments described above, when signed product history data are received from a client for which authentication has succeeded, the data storage unit 141 registers the signed product history data in the data store 142. However, the client for which authentication has succeeded may directly register the signed product history data in the data store 142 without passing through the data storage unit 141.

In the example embodiments described above, the present disclosure has been described as a hardware configuration, but the present disclosure is not limited thereto. According to the present disclosure, any processing can also be implemented by causing a processor to execute a computer program.

The program can be stored using various types of non-transitory computer readable media to be supplied to a computer. The non-transitory computer readable media include various types of tangible storage media. Examples of non-transitory computer readable media include a magnetic recording medium (e.g., a flexible disk, a magnetic tape, or a hard disk drive), a magneto-optical recording medium (e.g., a magneto-optical disk), a CD-read only memory (ROM), a CD-R, a CD-R/W, and a semiconductor memory (e.g., a mask ROM, a programmable ROM (PROM), an erasable PROM (EPROM), a flash ROM, and a random access memory (RAM). In addition, the programs may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

Some or all of the example embodiments described above can be described as in the following supplementary notes, but are not limited to the following supplementary notes.

### (Supplementary Note 1)

A product management system including:
an issuance means for, in case of receiving a certificate issuance request from a product device including a hardware security module (HSM), generating a public key certificate including a public key of the product device, a UID that is information for uniquely identifying the product device, and a signature of a certificate authority, and setting a secret key that is paired with the public key of the product device in the HSM;
an authentication means for, in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
a data registration means for registering product history data of the product device in association with the UID of the product device; and
an output means for, in case of receiving a use start request from the product device for which the authentication has succeeded, reading the product history data registered in association with the UID by using at least the UID included in the public key certificate of the product device, and outputting output information regarding the product history data.

### (Supplementary Note 2)

The product management system according to supplementary note 1, in which
the product history data to be registered contain at least one of inspection data, inventory management data, distribution management data, verification data at a start of operation, maintenance data, and discard data of the product device.

### (Supplementary Note 3)

The product management system according to supplementary note 1 or 2, in which
the output means outputs a result of verifying whether the read product history data indicate a normal history as the output information.

### (Supplementary Note 4)

The product management system according to any one of supplementary notes 1 to 3, in which
in a case where the product history data are received from the product device for which the authentication has succeeded, the data registration means registers the product history data in association with the UID of the product device.

### (Supplementary Note 5)

The product management system according to any one of supplementary notes 1 to 4, in which
in case of receiving a certificate issuance request from an SCM device related to a supply chain of the product device, the issuance means generates a public key certificate including at least a public key of the SCM device, and sets a secret key that is paired with the public key of the SCM device in an HSM of the SCM device, and
in case of receiving, from the SCM device, an authentication request including the public key certificate and authentication data to which a signature for the SCM device is attached, the authentication means:
   verifies the public key certificate included in the authentication request by using the CA public key;
   verifies whether the authentication data are signed with the secret key that is paired with the public key by using the public key in the public key certificate included in the authentication request; and
   determines that authentication has succeeded in a case where the verification of the public key certificate included in the authentication request has succeeded and the verification of the signature attached to the authentication data has succeeded.

### (Supplementary Note 6)

The product management system according to supplementary note 5, in which
in case of receiving at least one substitute ID for specifying the UID of the product device and product history data of the product device from the SCM device for which the authentication has succeeded, the data registration means registers the product history data in association with the at least one substitute ID, and
in case of receiving a use start request from the product device for which the authentication has succeeded, the output means reads the product history data registered in association with the at least one substitute ID for specifying the UID in addition to the product history data registered in association with the UID of the product device.

### (Supplementary Note 7)

The product management system according to supplementary note 6, in which
the at least one substitute ID includes at least one of a model number, a serial number, and a distribution slip number of the product device, or a combination thereof.

### (Supplementary Note 8)

The product management system according to any one of supplementary notes 1 to 7, in which
when registering the product history data, the data registration means stores a hash value of the product history data in a blockchain.

### (Supplementary Note 9)

The product management system according to supplementary note 8, in which
the output means outputs the output information in which a result of verifying a block corresponding to the read product history data in the blockchain is included.

### (Supplementary Note 10)

The product management system according to any one of supplementary notes 1 to 9, in which
the output means transmits the output information to a terminal used by a user of the product device.

### (Supplementary Note 11)

A product device configured to:
set, in case of receiving a public key certificate including a public key and a UID from the product management system according to any one of supplementary notes 1 to 10, a secret key that is paired with the public key in an HSM and store the public key certificate in a storage; and
sign, when activated, authentication data by using the secret key set in the HSM, and transmit an authentication request including the public key certificate stored in the storage and the signed authentication data to the product management system.

### (Supplementary Note 12)

A product management method including:
generating, in case of receiving a certificate issuance request from a product device including a hardware security module (HSM), a public key certificate including a public key of the product device, a UID that is information for uniquely identifying the product device, and a signature of a certificate authority, and setting a secret key that is paired with the public key of the product device in the HSM;
in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
registering product history data of the product device in association with the UID of the product device; and
reading, in case of receiving a use start request from the product device for which the authentication has succeeded, the product history data registered in association with the UID by using at least the UID included in the public key certificate of the product device, and outputting output information regarding the product history data.

### (Supplementary Note 13)

A non-transitory computer readable medium storing a program for causing a computer to implement:
a function of, in case of receiving a certificate issuance request from a product device including a hardware security module (HSM), generating a public key certificate including a public key of the product device, a UID that is information for uniquely identifying the product device, and a signature of a certificate authority, and setting a secret key that is paired with the public key of the product device in the HSM;
a function of, in case of receiving, from the product device, an authentication request including the public key certificate and authentication data to which the signature for the product device is attached,
   verifying the public key certificate included in the authentication request by using a CA public key that is paired with a CA secret key used for the signature by the certificate authority,
   verifying whether the authentication data are signed with the secret key that is paired with the public key by using the public key in the public key certificate included in the authentication request, and
   determining that authentication has succeeded in a case where the verification of the public key certificate included in the authentication request has succeeded and the verification of the signature attached to the authentication data has succeeded;
a function of registering product history data of the product device in association with the UID of the product device; and
a function of, in case of receiving a use start request from the product device for which the authentication has succeeded, reading the product history data registered in association with the UID by using at least the UID included in the public key certificate of the product device, and outputting output information regarding the product history data.

### REFERENCE SIGNS LIST

1, 1a SYSTEM
10, 10a, 10b PRODUCT MANAGEMENT SYSTEM
11 ISSUANCE UNIT
12 AUTHENTICATION UNIT
13 DATA REGISTRATION UNIT
14 OUTPUT UNIT
20, 20a PRODUCT DEVICE
21 COMMUNICATION UNIT
22 CONTROL UNIT
23 HSM
24 STORAGE
31 PRODUCTION APPARATUS
32 INSPECTION DEVICE
40 SCM DEVICE
50 USER TERMINAL
100 API GATEWAY
120 USER MANAGEMENT UNIT
110 DEVICE MANAGEMENT UNIT
111 CERTIFICATE MANAGEMENT UNIT
112 CERTIFICATE AUTHORITY
130 DEVICE VERIFICATION UNIT
140, 140b DATA VERIFICATION UNIT
141, 141b DATA STORAGE UNIT
142 DATA STORE
144 BLOCKCHAIN
150 SCM INTEGRATED MANAGEMENT UNIT
210 COMMUNICATION UNIT
220 CONTROL UNIT
230 STORAGE
231 TPM
240 DATA ACQUISITION UNIT
410 COMMUNICATION UNIT
420 CONTROL UNIT
430 STORAGE
431 TPM
440 DATA ACQUISITION UNIT
N NETWORK

What is claimed is:

1. A product management system comprising:
at least one memory storing instructions; and
at least one processor configured to execute the instructions to:
generate, in case of receiving a certificate issuance request from a product device including a hardware security module (HSM), a public key certificate including a public key of the product device, a UID that is information for uniquely identifying the product device, and a signature of a certificate authority, and set a secret key that is paired with the public key of the product device in the HSM;
in case of receiving, from the product device, an authentication request including the public key certificate and authentication data to which the signature for the product device is attached,
verify the public key certificate included in the authentication request by using a CA public key that is paired with a CA secret key used for the signature by the certificate authority,
verify whether the authentication data are signed with the secret key that is paired with the public key by using the public key in the public key certificate included in the authentication request, and
determine that authentication has succeeded in a case where the verification of the public key certificate included in the authentication request has succeeded and the verification of the signature attached to the authentication data has succeeded;
register product history data of the product device in association with the UID of the product device; and
read, in case of receiving a use start request from the product device for which the authentication has succeeded, the product history data registered in association with the UID by using at least the UID included in the public key certificate of the product device, and output information regarding the product history data.

2. The product management system according to claim 1, wherein
the product history data to be registered contain at least one of inspection data, inventory management data, distribution management data, verification data at a start of operation, maintenance data, and discard data of the product device.

3. The product management system according to claim 1, wherein
the at least one processor is further configured to execute the instructions to output a result of verifying whether the read product history data indicate a normal history as the output information.

4. The product management system according to claim 1, wherein
in a case where the product history data are received from the product device for which the authentication has succeeded, the at least one processor is further configured to execute the instructions to register the product history data in association with the UID of the product device.

5. The product management system according to claim 1, wherein
in case of receiving a certificate issuance request from an SCM device related to a supply chain of the product device, the at least one processor is further configured to execute the instructions to generate a public key certificate including at least a public key of the SCM device, and set a secret key that is paired with the public key of the SCM device in an HSM of the SCM device, and
in case of receiving, from the SCM device, an authentication request including the public key certificate and authentication data to which a signature for the SCM device is attached, the at least one processor is further configured to execute the instructions to:
verify the public key certificate included in the authentication request by using the CA public key;
verify whether the authentication data are signed with the secret key that is paired with the public key by using the public key in the public key certificate included in the authentication request; and
determine that authentication has succeeded in a case where the verification of the public key certificate included in the authentication request has succeeded and the verification of the signature attached to the authentication data has succeeded.

6. The product management system according to claim 5, wherein
in case of receiving at least one substitute ID for specifying the UID of the product device and product history data of the product device from the SCM device for which the authentication has succeeded, the at least one processor is further configured to execute the instructions to register the product history data in association with the at least one substitute ID, and
in case of receiving a use start request from the product device for which the authentication has succeeded, the at least one processor is further configured to execute the instructions to read the product history data registered in association with the at least one substitute ID for specifying the UID in addition to the product history data registered in association with the UID of the product device.

7. The product management system according to claim 6, wherein
the at least one substitute ID includes at least one of a model number, a serial number, and a distribution slip number of the product device, or a combination thereof.

8. The product management system according to claim 1, wherein
when registering the product history data, the at least one processor is further configured to execute the instructions to store a hash value of the product history data in a blockchain.

9. The product management system according to claim 8, wherein
the at least one processor is further configured to execute the instructions to output the output information in which a result of verifying a block corresponding to the read product history data in the blockchain is included.

10. The product management system according to claim 1, wherein
the at least one processor is further configured to execute the instructions to transmit the output information to a terminal used by a user of the product device.

11. A product device configured to:
set, in case of receiving a public key certificate including a public key and a UID from the product management system according to claim 1, a secret key that is paired with the public key in an HSM and store the public key certificate in a storage; and
sign, when activated, authentication data by using the secret key set in the HSM, and transmit an authentication request including the public key certificate stored in the storage and the signed authentication data to the product management system.

12. A product management method comprising:
generating, in case of receiving a certificate issuance request from a product device including a hardware security module (HSM), a public key certificate including a public key of the product device, a UID that is information for uniquely identifying the product device, and a signature of a certificate authority, and setting a secret key that is paired with the public key of the product device in the HSM;
in case of receiving, from the product device, an authentication request including the public key certificate and authentication data to which the signature for the product device is attached,
verifying the public key certificate included in the authentication request by using a CA public key that is paired with a CA secret key used for the signature by the certificate authority,
verifying whether the authentication data are signed with the secret key that is paired with the public key by using the public key in the public key certificate included in the authentication request, and
determining that authentication has succeeded in a case where the verification of the public key certificate included in the authentication request has succeeded and the verification of the signature attached to the authentication data has succeeded;
registering product history data of the product device in association with the UID of the product device; and
reading, in case of receiving a use start request from the product device for which the authentication has succeeded, the product history data registered in association with the UID by using at least the UID included in the public key certificate of the product device, and outputting output information regarding the product history data.

13. A non-transitory computer readable medium storing a program for causing a computer to implement:
a function of, in case of receiving a certificate issuance request from a product device including a hardware security module (HSM), generating a public key certificate including a public key of the product device, a UID that is information for uniquely identifying the product device, and a signature of a certificate authority, and setting a secret key that is paired with the public key of the product device in the HSM;
a function of, in case of receiving, from the product device, an authentication request including the public key certificate and authentication data to which the signature for the product device is attached,
verifying the public key certificate included in the authentication request by using a CA public key that is paired with a CA secret key used for the signature by the certificate authority,
verifying whether the authentication data are signed with the secret key that is paired with the public key by using the public key in the public key certificate included in the authentication request, and
determining that authentication has succeeded in a case where the verification of the public key certificate included in the authentication request has succeeded and the verification of the signature attached to the authentication data has succeeded;
a function of registering product history data of the product device in association with the UID of the product device; and
a function of, in case of receiving a use start request from the product device for which the authentication has succeeded, reading the product history data registered in association with the UID by using at least the UID included in the public key certificate of the product device, and outputting output information regarding the product history data.
